(19) United States
(12) Patent Application Publication
(10) Pub. No.: US 2026/0249815 A1
(43) Pub. Date: Aug. 27, 2026

(54) SECURITY MONITORING DEVICE, SECURITY MONITORING SYSTEM, AND SECURITY MONITORING METHOD

(71) Applicant: Panasonic Automotive Systems Co., Ltd., Kanagawa (JP)

(72) Inventors: Ryo HIRANO, Osaka (JP); Yoshiharu IMAMOTO, Kanagawa (JP); Seiji SAKAKI, Kanagawa (JP)

(73) Assignee: Panasonic Automotive Systems Co., Ltd., Kanagawa (JP)

(21) Appl. No.: 19/365,726

(22) Filed: Oct. 22, 2025

(30) Foreign Application Priority Data
Dec. 25, 2024 (JP) 2024-229231

(51) Int. Cl. B60R 25/30; H04L 9/40

(52) U.S. Cl. CPC B60R 25/307; H04L 63/1441; B60R 2325/106

(57) ABSTRACT

A security monitoring device includes: a security executor that executes security protection for a vehicle system; a test pattern instructor that causes the security executor to run in a test pattern; and a verifier that verifies, based on an output of the security executor that has run in the test pattern, whether the security executor is anomalous.

### CROSS REFERENCE TO RELATED APPLICATION

The present application is based on and claims priority of Japanese Patent Application No. 2024-229231 filed on December 25, 2024.

### FIELD

The present disclosure relates to a security monitoring device, a security monitoring system, and a security monitoring method.

### BACKGROUND

Conventionally, a driving system that automatically performs vehicle driving operation such as acceleration, deceleration, steering, and braking has been known. This driving system includes a plurality of electronic control units (ECUs) for controlling the vehicle driving operation. If the ECUs come under a cyberattack, the driving system may malfunction.

Patent Literature (PTL) 1 discloses a technique for determining the security state of a vehicle system by using an external port scan.

### Citation List

### Patent Literature

PTL 1: Japanese Unexamined Patent Application Publication No. 2016-177371

### SUMMARY

However, the technique according to PTL 1 can be improved upon.

In view of the above, the present disclosure provides a security monitoring device and the related technologies capable of improving upon the above related art.

A security monitoring device according to an aspect of the present disclosure includes: a security executor that executes security protection for a vehicle system; a test pattern instructor that causes the security executor to run in a test pattern; and a verifier that verifies, based on an output of the security executor that has run in the test pattern, whether the security executor is anomalous.

A security monitoring system according to an aspect of the present disclosure includes: the security monitoring device described above; and a monitoring server that communicates with the security monitoring device via an external network.

A security monitoring method according to an aspect of the present disclosure includes: causing a security executor to run in a test pattern, the security executor executing security protection for a vehicle system; and verifying, based on an output of the security executor that has run in the test pattern, whether the security executor is anomalous.

Note that these general or specific aspects may be implemented using a system, a method, an integrated circuit, a computer program, or a computer-readable recording medium such as a compact disc-read only memory (CD-ROM), or any combination of systems, methods, integrated circuits, computer programs, and recording media.

A security monitoring device and the related technologies according to an aspect of the present disclosure are capable of improving upon the above related art.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a block diagram illustrating a configuration of a security monitoring system according to an embodiment.

FIG. 2 is a block diagram illustrating an example of a configuration of a vehicle system included in a security monitoring system.

FIG. 3 is a block diagram illustrating an example of a configuration of an integrated ECU included in a vehicle system.

FIG. 4 is a block diagram illustrating a configuration of a security monitoring device according to an embodiment.

FIG. 5 is a diagram illustrating test patterns and results expected from the test patterns stored in a storage of a security monitoring device.

FIG. 6 is a diagram illustrating an example of an output of a security executor when the security executor has run in a test pattern.

FIG. 7 is a diagram illustrating an example of countermeasure patterns for when a security executor is determined to be anomalous.

FIG. 8 is a block diagram illustrating another example of a configuration of an integrated ECU.

FIG. 9 is a flowchart illustrating a security monitoring method according to an embodiment.

### DESCRIPTION OF EMBODIMENTS

### Circumstances Leading to the Present Disclosure

A cockpit domain controller (CDC) that integrates the functions of, for example, an infotainment system, a cluster, and an electronic mirror has been developed with the aim of supporting high-speed communication, reducing weight, and streamlining function development. With the cockpit domain controller, each function is implemented in a virtual machine on a virtualization platform such as a hypervisor. This virtual machine is connected to the outside via a network to transmit and receive various types of information. If the virtual machine is unauthorizedly accessed via the network, the vehicle safety may be adversely affected.

In view of the above, a security executor that executes security protection for the vehicle system is provided in the vehicle to ensure the vehicle safety. However, after the vehicle is handed over to the user, it is difficult to check whether the security executor is functioning normally.

In view of the above, according to the present disclosure, a self-check function of checking whether the security executor is functioning normally is provided in the vehicle. The self-check function is implemented by a security monitoring device provided in the vehicle. The security monitoring device is a device that causes the security executor to run in a test pattern, and verifies, based on an output of the security executor that has run in the test pattern, whether the security executor is anomalous. This device makes it possible to appropriately determine the security state of the vehicle system.

Hereinafter, exemplary embodiments will be specifically described with reference to the Drawings. Note that the embodiments described below each illustrate a general or specific example. The numerical values, shapes, materials, constituent elements, the arrangement and connection of the constituent elements, steps, the processing order of the steps etc. shown in the following embodiments are mere examples, and do not intend to limit the present disclosure. Also, among the constituent elements in the following embodiments, those not recited in any one of the independent claims representing the most generic concepts will be described as optional constituent elements.

### Embodiment

### Configurations of Security Monitoring System and Security Monitoring Device

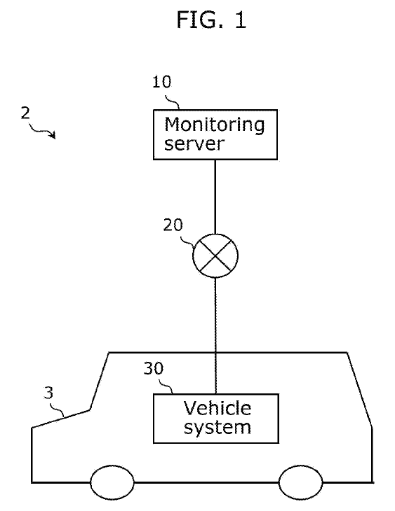

With reference to FIG. 1 through FIG. 8, configurations of a security monitoring system and a security monitoring device according to an embodiment will be described.

FIG. 1 is a block diagram illustrating a configuration of security monitoring system 2 according to an embodiment.

As illustrated in FIG. 1, security monitoring system 2 includes monitoring server 10 and vehicle system 30. Monitoring server 10 and vehicle system 30 are connected via external network 20 to communicate with each other.

External network 20 is a communication network such as the Internet. Monitoring server 10 is a cloud server, for example, and transmits and receives various types of information to and from vehicle system 30 via external network 20. Vehicle system 30 refers to all the systems included in vehicle 3.

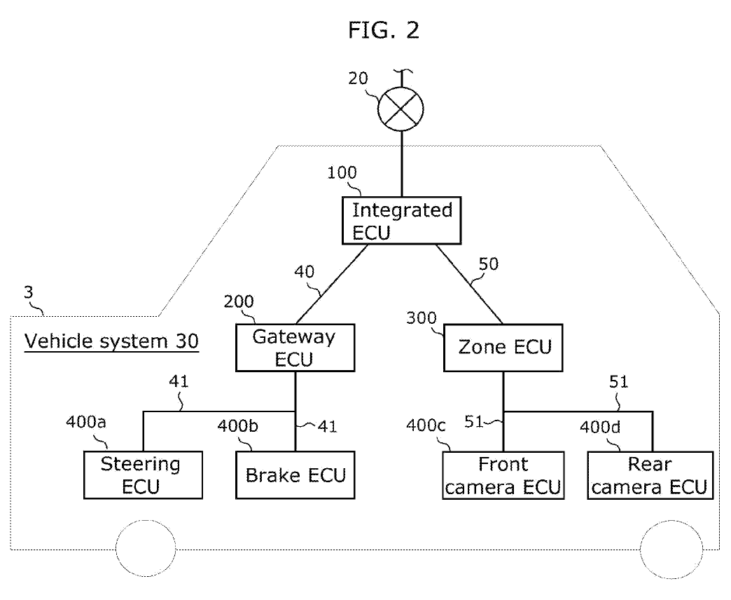

FIG. 2 is a block diagram illustrating a configuration of vehicle system 30 included in security monitoring system 2.

As illustrated in FIG. 2, vehicle system 30 includes integrated ECU 100, gateway ECU 200, steering ECU 400a, brake ECU 400b, zone ECU 300, front camera ECU 400c, and rear camera ECU 400d.

Integrated ECU 100 is a device that integrates a plurality of ECUs. Integrated ECU 100 is connected to monitoring server 10 via external network 20. Security monitoring device 1 according to the present disclosure is provided to integrated ECU 100.

Gateway ECU 200 is an ECU that aggregates a plurality of multiplex communications and relays communication. Gateway ECU 200 is connected to integrated ECU 100 via control area network (CAN) 40. Steering ECU 400a is an ECU that controls steering operation of vehicle 3. Steering ECU 400a is connected to gateway ECU 200 via CAN 41. Brake ECU 400b is an ECU that controls the brake and accelerator of vehicle 3. Brake ECU 400b is connected to gateway ECU 200 via CAN 41.

Zone ECU 300 is an ECU that collects information on each zone in vehicle 3. Zone ECU 300 is connected to integrated ECU 100 via Ethernet 50. Front camera ECU 400c is an ECU that controls a front camera provided to vehicle 3. Front camera ECU 400c is connected to zone ECU 300 via Ethernet 51. Rear camera ECU 400d is an ECU that controls a rear camera provided to vehicle 3. Rear camera ECU 400d is connected to zone ECU 300 via Ethernet 51.

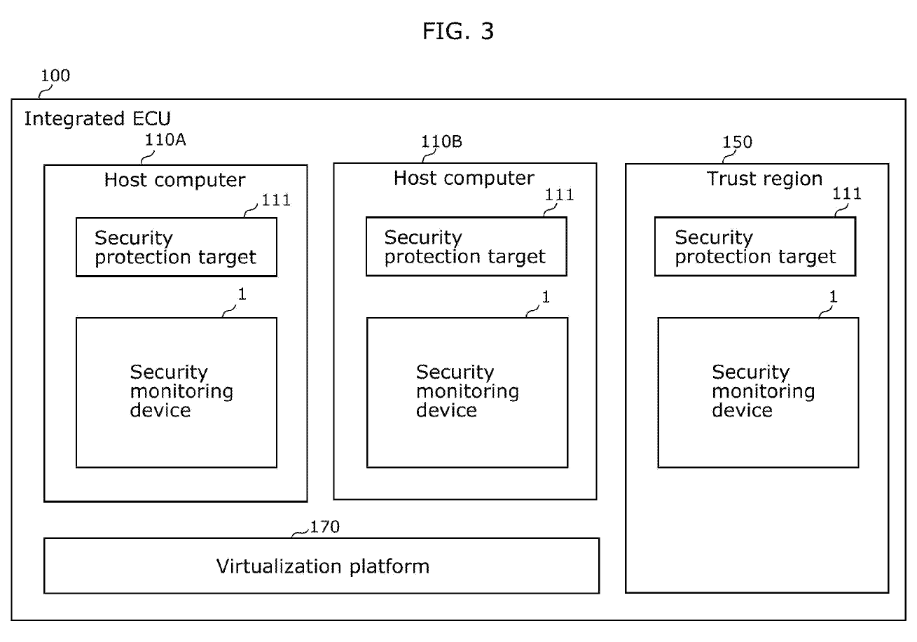

FIG. 3 is a block diagram illustrating an example of a configuration of integrated ECU 100 included in vehicle system 30.

As illustrated in FIG. 3, integrated ECU 100 includes a plurality of host computers 110A and 110B, trust region 150, and virtualization platform 170.

Virtualization platform 170 is virtualization software that controls the plurality of host computers 110A and 110B. Virtualization platform 170 is a hypervisor (registered trademark), for example. Each of host computers 110A and 110B is a virtual machine that operates on virtualization platform 170. Trust region 150 is a region designed to be more secure against cyberattacks than host computers 110A and 110B. Trust region 150 is, for example, a secure OS, a trusted execution environment (TEE), or a TrustZone (registered trademark).

As illustrated in FIG. 3, each of host computers 110A and 110B includes security protection target 111 and security monitoring device 1.

Security protection target 111 is a device whose security is to be protected. Security protection target 111 is also called a protection target process. Security protection target 111 is, for example, a controller of a car navigation device, a speed meter, or the like, and can be a cyberattack target. In view of this, vehicle system 30 includes security executor 112 to execute security protection for security protection target 111.

Security monitoring device 1 is a device that determines the security state of vehicle system 30.

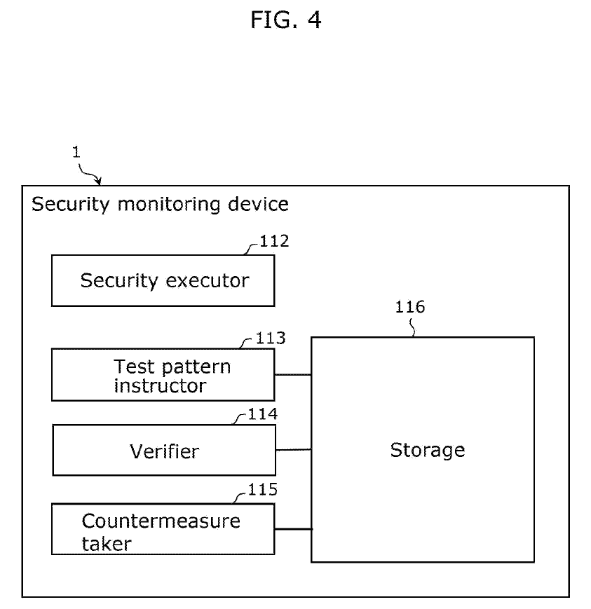

FIG. 4 is a block diagram illustrating a configuration of security monitoring device 1.

As illustrated in FIG. 4, security monitoring device 1 includes security executor 112, test pattern instructor 113, verifier 114, countermeasure taker 115, and storage 116. Storage 116 is, for example, a rewritable non-volatile memory.

Security executor 112 executes security protection for security protection target 111. Examples of security executor 112 include discretionary access control (DAC), security-enhanced Linux (SELinux, Linux: registered trademark), seccomp, Namespace, unshare, cgroup, Firewall (registered trademark), a network-based intrusion detection system (NIDS), Secureboot, and dm-verity.

For example, SELinux executes security protection related to discretionary access control or mandatory access control. Seccomp executes security protection related to system call restriction. Namespace and unshare execute security protection related to isolation of namespaces. Cgroup executes security protection related to restriction on a computational resource. Firewall and NIDS execute security protection related to communication monitoring. Secureboot and dm-verity execute security protection related to software of vehicle system 30.

In some cases, an attack through a cyberattack reaches not only security protection target 111 but also security executor 112 that protects security protection target 111. Security protection target 111 cannot be appropriately protected if an anomaly occurs in security executor 112 due to a cyberattack, for example. To address this, according to the present embodiment, it is verified whether security executor 112 is anomalous.

Test pattern instructor 113 illustrated in FIG. 4 causes security executor 112 to run in a test pattern. The test pattern includes control information for causing security executor 112 to output an off-normal event different from a normal event. Verifier 114 verifies, based on the output of security executor 112 that has run in the test pattern, whether security executor 112 is anomalous.

Note that the off-normal event is not an event that occurs to vehicle 3 at normal times but an event specially set for detecting whether security executor 112 is anomalous. Vehicle system 30 can perform operation control on vehicle 3 without any problem even when an off-normal event is output from security executor 112, for example. Hereinafter, constituent elements included in security monitoring device 1 will be described in detail.

Based on test patterns stored in storage 116, test pattern instructor 113 causes security executor 112 to run in a test pattern.

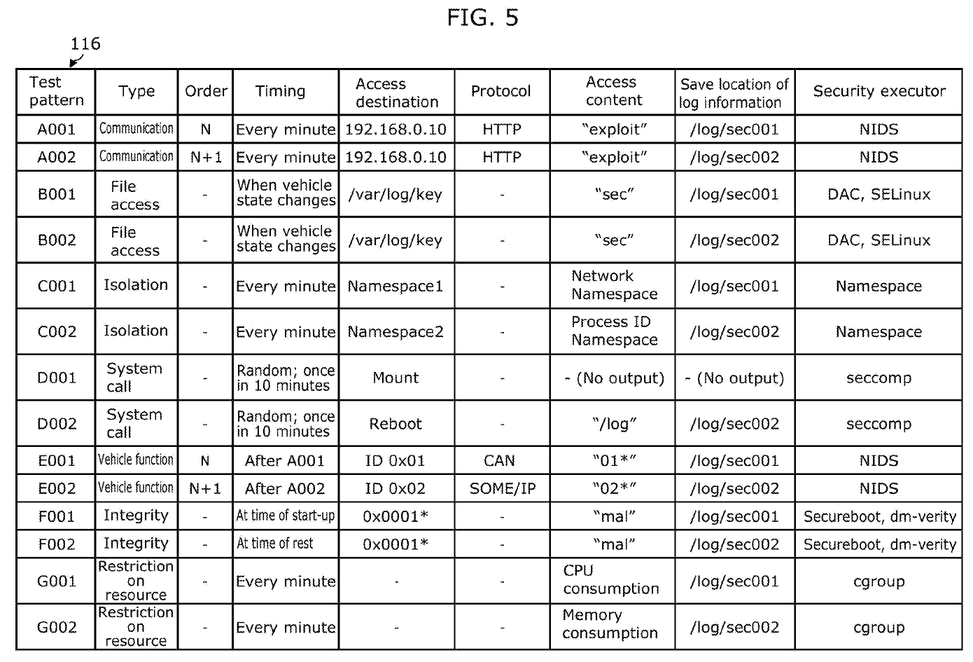

FIG. 5 is a diagram illustrating test patterns and results expected from the test patterns stored in storage 116 of security monitoring device 1. Such information is stored in storage 116 in advance.

FIG. 5 illustrates that an NIDS, which is an example of security executor 112, runs in test patterns A001 and A002, and also illustrates results (expected values) expected from such running. In this example, off-normal events that are output from security executor 112 are the results expected from the running in test patterns A001 and A002.

Specifically, FIG. 5 illustrates that: each of test patterns A001 and A002 is a test related to communication; the NIDS runs in test patterns A001 and A002 in the stated order; and the NIDS runs in each of test patterns A001 and A002 on a regular basis of every minute. As the result expected from test pattern A001, for example, the diagram illustrates that: the save location of log information that is output from the NIDS is “/log/sec001”; the access destination of test pattern A001 included in the log information is “192.168.0.10”; the protocol is “HTTP”; and access content is “exploit”. Note that the expected result also includes recording of, as log information, the running results of test patterns A001 and A002 in the stated order; and recording of, as log information, the running results of test patterns A001 and A002 on a regular basis of every minute.

In such a manner, test pattern instructor 113 causes security executor 112 to run in a test pattern to cause transmission of an unauthorized signal to the NIDS that is an example of security executor 112.

FIG. 5 further illustrates that DAC and SELinux, which are examples of security executor 112, run in test patterns B001 and B002, and also illustrates results expected from such running. In this example, too, off-normal events that are output from security executor 112 are the results expected from the running in test patterns B001 and B002.

Specifically, FIG. 5 illustrates that each of test patterns B001 and B002 is a test related to file access, and that DAC and SELinux are caused to run in test patterns B001 and B002 when the vehicle state changes (that is, when a predetermined event occurs). As the result expected from test pattern B001, for example, the diagram illustrates that: the save location of log information that is output from DAC and SELinux is “/log/sec001”; the access destination of test pattern B001 included in the log information is “/var/log/key”; and access content is “sec”. Note that the expected result also includes recording of, as log information, the running results of test patterns B001 and B002 when the vehicle state changes.

In such a manner, test pattern instructor 113 causes security executor 112 to run in a test pattern to cause execution of an unpermitted access to DAC and SELinux that are examples of security executor 112.

FIG. 5 further illustrates that Namespace, which is an example of security executor 112, runs in test patterns C001 and C002, and also illustrates results expected from such running. In this example, too, off-normal events that are output from security executor 112 are the results expected from the running in test patterns C001 and C002.

Specifically, FIG. 5 illustrates that each of test patterns C001 and C002 is a test related to isolation, and that Namespace is caused to run in test patterns C001 and C002 on a regular basis of every minute. As the result expected from test pattern C001, for example, the diagram illustrates that: the save location of log information that is output from Namespace monitoring is “/log/sec001”; the access destination of test pattern C001 included in the log information is “Namespace1”; and access content is “Network Namespace”. Here, Namespace monitoring is a process of checking that Namespace is correctly isolated. For example, when the network Namespace is “Namespace1”, it is possible to check that “Namespace1” is correctly isolated, by checking that message queue communication cannot be performed from the process of “Namespace2” to the process of “Namespace1”. Further, when the network device that belongs to “Namespace1” is eth1 only, it is possible to check that “Namespace1” is correctly isolated, by checking the network device that is a resource belonging to “Namespace1” and confirming that the network device is eth1 only. Also, for example, when the process ID namespace is “Namespace2”, it is possible to check that “Namespace2” is correctly isolated, by checking that the process name and process identification (ID) that do not belong to “Namespace2” are not displayed in “Namespace2”. Note that the expected result also includes recording of, as log information, the running results of test patterns C001 and C002 on a regular basis of every minute.

Test pattern instructor 113 may cause security executor 112 to run in a test pattern to check the namespace for the presence of a process or resource of another namespace different from the namespace.

FIG. 5 illustrates that seccomp, which is an example of security executor 112, runs in test patterns D001 and D002, and also illustrates results expected from such running. In this example, too, off-normal events that are output from security executor 112 are the results expected from the running in test patterns D001 and D002.

Specifically, FIG. 5 illustrates that each of test patterns D001 and D002 is a test related to a system call, and that seccomp runs in test patterns D001 and D002 on a regular basis of once at a random timing in each of 10-minute periods. As the result expected from test pattern D001, the diagram illustrates that: the save location of log information that is output from seccomp is “No output”; the access destination of test pattern D001 included in the log information is “Mount”; and access content is “No output”. Here, since “Mount” is a system call permitted by seccomp, the expected value is that information on a denied system call is not output to the save location of the log information. As the result expected from test pattern D002, the diagram illustrates that: the save location of log information that is output from seccomp is “/log/sec002”, the access destination of test pattern D002 included in the log information is “Reboot”, and access content is “/log”. Here, since “Reboot” is a system call denied by seccomp, the expected value is that information on the denied system call is output to the save location of the log information. Note that the expected result includes recording of, as log information, the running results of test patterns D001 and D002 at a timing of once in each of 10-minute periods.

In such a manner, test pattern instructor 113 causes security executor 112 to run in a test pattern to cause execution of a permitted system call or an unpermitted system call on seccomp that is an example of security executor 112.

FIG. 5 further illustrates that an NIDS, which is an example of security executor 112, runs in test patterns E001 and E002, and also illustrates results expected from such running. In this example, off-normal events that are output from security executor 112 are the results expected from the running in test patterns E001 and E002.

Specifically, FIG. 5 illustrates that: each of test patterns E001 and E002 is a test related to vehicle function; the NIDS is caused to run in test patterns E001 and E002 in the stated order; and the NIDS is caused to run in test pattern E001 after test pattern A001 and to run in test pattern E002 after test pattern A002. As the result expected from test pattern E001, the diagram illustrates that: the save location of log information that is output from the NIDS is “/log/sec001”; the access destination of test pattern E001 included in the log information is “ID 0x01”; protocol is “CAN”; and access content is “01”. As the result expected from test pattern E002, the diagram illustrates that: the save location of log information that is output from the NIDS is “/log/sec002”; the access destination of test pattern E002 included in the log information is “ID 0x02”; protocol is “SOME/IP”; and access content is “02”. Note that the expected result also includes: recording of, as log information, the running results of test patterns E001 and E002 in the stated order; recording of, as log information, the running result of test pattern E001 at a timing after test pattern A001; and recording of, as log information, the running result of test pattern E002 at a timing after test pattern A002.

In such a manner, test pattern instructor 113 causes security executor 112 to run in a test pattern to cause execution of an unpermitted access to the NIDS that is an example of security executor 112.

FIG. 5 further illustrates that Secureboot and dm-verity, which are examples of security executor 112, run in test patterns F001 and F002, and also illustrates results expected from such running. In this example, off-normal events that are output from security executor 112 are the results expected from the running in test patterns F001 and F002.

Specifically, FIG. 5 illustrates that each of test patterns F001 and F002 is a test related to integrity, and that Secureboot and dm-verity are caused to run in test pattern F001 at the time of start-up and to run in test pattern F002 at the time of reset. As the result expected from test pattern F001, for example, the diagram illustrates that: the save location of log information that is output from Secureboot and dm-verity is “/log/sec001”; the access destination of test pattern F001 included in the log information is “0x0001”; and access content is “mal”. Specifically, it is an operation of writing [mal] into region [0x0001] of a non-volatile memory, and as a result of verification of the integrity of Secureboot and dm-verity, it is verified to be unauthorized data writing, and a log is thereby output. Here, although Secureboot and dm-verity are security functions that are caused to run at the time of start-up, they may be security functions that are intended for integral monitoring of software and caused to run during run time after start-up. Note that the expected result also includes: recording of, as log information, the running result of test pattern F001 at the time of start-up; and recording of, as log information, the running result of test pattern F002 at the time of reset.

In such a manner, test pattern instructor 113 causes Secureboot and dm-verity, which are examples of security executor 112, to run in a test pattern to cause the software of vehicle system 30 to be temporarily tampered with.

FIG. 5 further illustrates that cgroup, which is an example of security executor 112, runs in test patterns G001 and G002, and also illustrates results expected from such running. In this example, off-normal events that are output from security executor 112 are the results expected from the running in test patterns G001 and G002.

Specifically, FIG. 5 illustrates that each of test patterns G001 and G002 is a test related to restriction on a computational resource, and that cgroup is caused to run in each of test patterns G001 and G002 every minute. As the result expected from test pattern G001, the diagram illustrates that: the save location of log information that is output from cgroup is “/log/sec001”; and access content of test pattern G001 included in the log information is “CPU (central processing unit) consumption”. Test pattern instructor 113 may increase the CPU consumption by an infinite loop, for example. As the result expected from test pattern G002, the diagram illustrates that: the save location of log information that is output from cgroup is “/log/sec002”; and access content of test pattern G002 included in the log information is “memory consumption”. Test pattern instructor 113 may increase the memory consumption by securing a lot of memory. Note that the expected result also includes recording of, as log information, the running result of test pattern G001 every minute.

In such a manner, test pattern instructor 113 causes cgroup, which is an example of security executor 112, to run in a test pattern to cause consumption of the computational resource to a predetermined value. Also, by checking the set value of cgroup, it is possible to check whether the set value has been changed.

As described earlier, verifier 114 verifies, based on the output of security executor 112 that has run in the test pattern, whether security executor 112 is anomalous. For example, verifier 114 determines that security executor 112 is not anomalous when log information indicating the output of security executor 112 matches the result expected from the test pattern. Verifier 114 determines that security executor 112 is anomalous when the log information does not match the result expected.

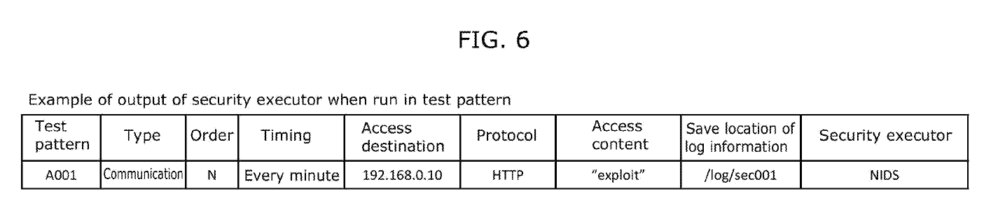

FIG. 6 is a diagram illustrating an example of the output of security executor 112 when security executor 112 has run in a test pattern.

FIG. 6 illustrates a running result obtained when the NIDS, which is an example of security executor 112, has run in test pattern A001 related to communication. As the running result, the diagram illustrates that: the save location of log information that is output from the NIDS is “/log/sec001”; the access destination of test pattern A001 included in the log information is “192.168.0.10”; the protocol is “HTTP”, and access content is “exploit”. Note that the diagram also illustrates that the running result of test pattern A001 has been output on a regular basis of every minute.

In this case, log information that is output from security executor 112 matches the result expected from test pattern A001, so verifier 114 determines that security executor 112 is not anomalous. That is to say, verifier 114 determines that the security of security executor 112 is not anomalous when the log information indicating the output of security executor 112 matches the off-normal event expected from the test pattern.

On the other hand, verifier 114 determines that security executor 112 has been unauthorizedly manipulated, when the log information output from security executor 112 does not match the result expected from test pattern A001. That is to say, verifier 114 determines that security executor 112 has been unauthorizedly manipulated, when the log information does not match the off-normal event expected.

Also, verifier 114 determines that security executor 112 has been disabled, when there is no output, from security executor 112, related to event information including an off-normal event, that is, when there is no output from security executor 112 at all.

Also, verifier 114 determines that security executor 112 has been unauthorizedly manipulated, when the off-normal event is output from security executor 112 at a time other than when test pattern instructor 113 has caused security executor 112 to run in a test pattern. In this case, verifier 114 may determine that a false response has been made through unauthorized manipulation.

In addition, verifier 114 may verify whether security executor 112 is anomalous, through the running caused by test pattern instructor 113 described below.

For example, test pattern instructor 113 causes security executor 112 to run in a test pattern at a predetermined timing. Verifier 114 may determine that security executor 112 is not anomalous, when the off-normal event is output from security executor 112 at the predetermined timing, and determine that security executor 112 is anomalous, when the off-normal event is not output from security executor 112 at the predetermined timing.

For example, test pattern instructor 113 causes security executor 112 to run in a test pattern on a regular basis. The timing at which to run in a test pattern on a regular basis is every minute, for example. Note that the timing at which to run in a test pattern on a regular basis is selected as appropriate from a range of from at least every 0.5 minutes to at most every 5 minutes. Verifier 114 may determine that security executor 112 is not anomalous, when the off-normal event is output from security executor 112 on the regular basis, and determine that security executor 112 is anomalous, when the off-normal event is not output from security executor 112 on the regular basis.

For example, test pattern instructor 113 causes security executor 112 to run in test patterns in an order determined in advance. The order determined in advance is an order stored in storage 116 in advance. Verifier 114 may determine that security executor 112 is not anomalous, when off-normal events are output from security executor 112 in the order determined in advance, and determine that security executor 112 is anomalous, when off-normal events are not output from security executor 112 in the order determined in advance.

For example, test pattern instructor 113 causes security executor 112 to run in test patterns on a random basis. The order of test patterns in which security executor 112 has been caused to run on a random basis is stored in storage 116. Verifier 114 may determine that security executor 112 is not anomalous, when off-normal events are output from security executor 112 on the random basis on which security executor 112 has run in the test patterns, and determine that security executor 112 is anomalous, when off-normal events are not output from security executor 112 on the random basis on which security executor 112 has run in the test patterns. Here, if security executor 112 is caused to run in test patterns completely at random, verifier 114 cannot determine whether off-normal events have been output. In view of this, running in test patterns on a random basis is to run in test patterns on a random basis within a predetermined range, and, as the output result, the determination regarding off-normal events is performed by checking that the randomness is within the predetermined range. Specifically, in the case of a system call, a system call is executed on a random basis from among predetermined 10 types of system calls, and it is determined that an off-normal event has been output when a log of execution of any one of the 10 types of system calls is present. For example, test pattern instructor 113 causes security executor 112 to run in a test pattern when a predetermined event occurs. The predetermined event is a normal event such as a start or a stop of vehicle 3. Verifier 114 may determine that security executor 112 is not anomalous, when an off-normal event is output from security executor 112 in response to occurrence of the predetermined event, and determine that security executor 112 is anomalous, when the off-normal event is not output from security executor 112 in response to occurrence of the predetermined event. The predetermined event is, for example, reception of an instruction to update software. An off-normal event is caused to occur to check that verification of software integrity is in proper operation. By doing so, it is possible to identify whether security executor 112 is anomalous.

Countermeasure taker 115 illustrated in FIG. 4 takes a countermeasure in accordance with whether security executor 112 is anomalous.

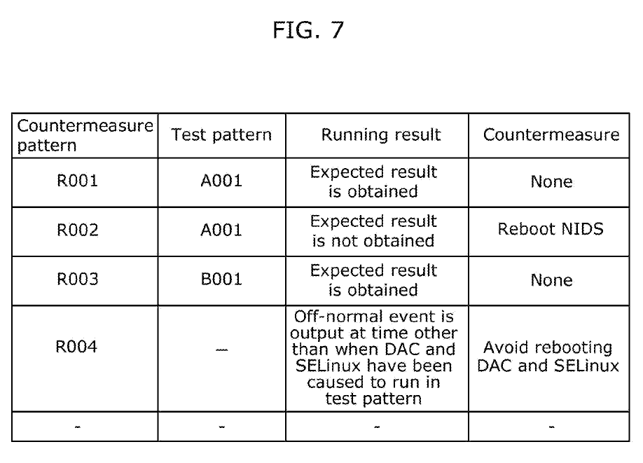

FIG. 7 is a diagram illustrating an example of countermeasure patterns for when security executor 112 is determined to be anomalous. These countermeasure patterns are stored in storage 116 in advance.

Countermeasure pattern R001 indicates that the countermeasure to be taken by countermeasure taker 115 is “None” when the expected result is obtained from the NIDS that has run in test pattern A001. That is to say, when verifier 114 determines that security executor 112 is not anomalous, countermeasure taker 115 avoids outputting information indicating that security executor 112 is anomalous.

Countermeasure pattern R002 indicates that countermeasure taker 115 reboots the NIDS when the expected result is not obtained from the NIDS that has run in test pattern A001. That is to say, countermeasure taker 115 reboots security executor 112 when an event different from the off-normal event is output from security executor 112 that has run in the test pattern. In this case, countermeasure taker 115 may output information indicating that security executor 112 is anomalous. The information indicating that security executor 112 is anomalous also includes information related to the NIDS that is security executor 112.

Countermeasure pattern R003 indicates that the countermeasure to be taken by countermeasure taker 115 is “None” when the expected result is obtained from the DAC and SELinux that have run in test pattern B001. That is to say, when verifier 114 determines that security executor 112 is not anomalous, countermeasure taker 115 avoids outputting information indicating that security executor 112 is anomalous.

Countermeasure pattern R004 indicates that countermeasure taker 115 avoids rebooting the DAC and SELinux when the off-normal event is output from the DAC and SELinux at a time other than when the DAC and SELinux have been caused to run in the test pattern. That is to say, countermeasure taker 115 avoids rebooting security executor 112 when the off-normal event is output from security executor 112 at a time other than when security executor 112 has been caused to run in the test pattern. In this case, countermeasure taker 115 may output information indicating that security executor 112 is anomalous.

Security monitoring device 1 according to the present embodiment includes: security executor 112 that executes security protection for vehicle system 30; test pattern instructor 113 that causes security executor 112 to run in a test pattern; and verifier 114 that verifies, based on an output of security executor 112 that has run in the test pattern, whether security executor 112 is anomalous. In such a manner, by verifying, based on the output of security executor 112 that has run in the test pattern, whether security executor 112 is anomalous, it is possible to determine the security state of vehicle system 30.

Note that the above description has illustrated an example where security executor 112, test pattern instructor 113, and verifier 114 are provided in the same host computer; however, the present disclosure is not limited to such an example. For example, each of security executor 112, test pattern instructor 113, and verifier 114 may be provided in a different host computer. In addition, each of security executor 112, test pattern instructor 113, and verifier 114 may be provided in a different ECU.

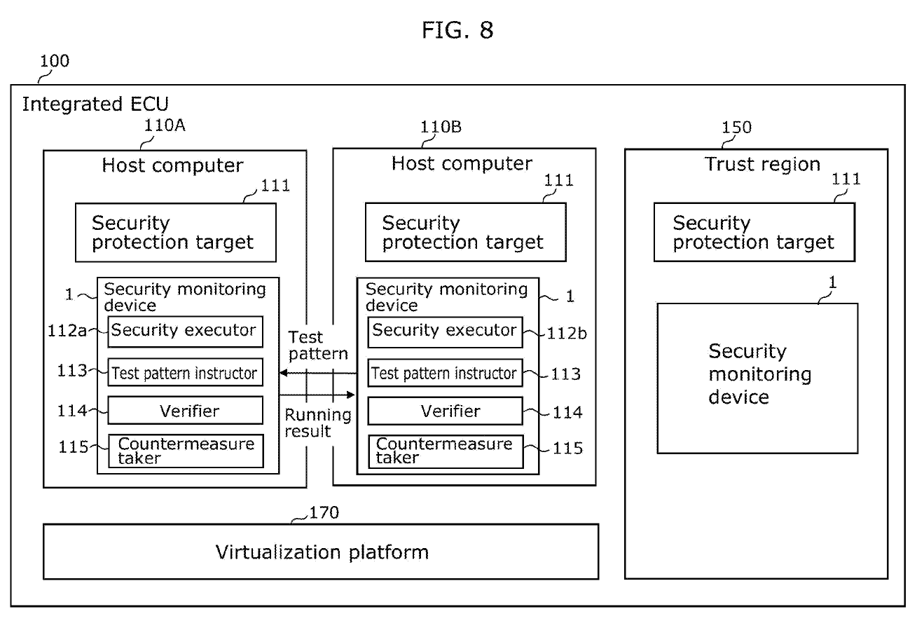

FIG. 8 is a block diagram illustrating another example of a configuration of integrated ECU 100. Note that FIG. 8 omits illustration of storage 116.

Integrated ECU 100 illustrated in FIG. 8 includes a plurality of host computers 110A and 110B, trust region 150, and virtualization platform 170. Each of host computers 110A and 110B includes security protection target 111 and security monitoring device 1. In the example illustrated in FIG. 8, host computer 110B is designed to be more secure against cyberattacks than host computer 110A is.

In this example, a test pattern is transmitted from security monitoring device 1 of host computer 110B to security monitoring device 1 of host computer 110A, and the running result of the test pattern is transmitted from security monitoring device 1 of host computer 110A to security monitoring device 1 of host computer 110B. With this configuration, too, the security state of vehicle system 30 can be determined.

In addition, in integrated ECU 100, test pattern instructor 113 of host computer 110A may cause each of first security executor 112a that is the security executor described above and second security executor 112b different from first security executor 112a to run in a test pattern in an order determined in advance. Verifier 114 of host computer 110A may determine that first security executor 112a and second security executor 112b are not anomalous, when an off-normal event is output from each of first security executor 112a and second security executor 112b in the order determined in advance.

The above description has illustrated an example where the processing is performed by test pattern instructor 113 and verifier 114 of host computer 110A; however, the present disclosure is not limited to such an example, and the same processing may be performed by test pattern instructor 113 and verifier 114 of host computer 110B.

That is to say, in integrated ECU 100, test pattern instructor 113 of host computer 110B may cause each of second security executor 112b that is the security executor described above and first security executor 112a different from second security executor 112b to run in a test pattern in an order determined in advance. Verifier 114 of host computer 110B may determine that first security executor 112a and second security executor 112b are not anomalous, when an off-normal event is output from each of output from first security executor 112a and second security executor 112b in the order determined in advance.

### Security Monitoring Method

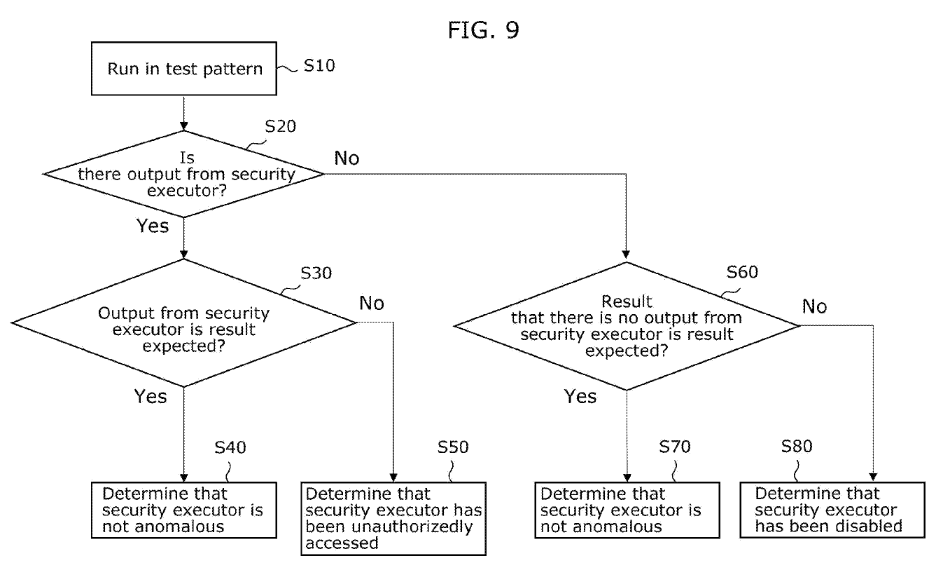

A security monitoring method according to the embodiment will be described with reference to FIG. 9.

FIG. 9 is a flowchart illustrating a security monitoring method according to the embodiment.

As illustrated in FIG. 9, security monitoring device 1 runs in a test pattern (step S10). Specifically, test pattern instructor 113 causes security executor 112 to run in a test pattern. The test pattern includes control information for causing security executor 112 to output an off-normal event different from a normal event.

Next, security monitoring device 1 determines whether there is an output from security executor 112 (step S20). Specifically, verifier 114 determines whether there is an output from security executor 112, by detecting log information indicating an output of security executor 112.

When there is an output from security executor 112 (Yes in S20), security monitoring device 1 determines whether the output from security executor 112 is the result expected from the test pattern (step S30).

When the output from security executor 112 is the result expected from the test pattern (Yes in step S30), security monitoring device 1 determines that security executor 112 is not anomalous (step S40). On the other hand, when the output from security executor 112 is not the result expected from the test pattern (No in step S30), security monitoring device 1 determines that security executor 112 has been unauthorizedly accessed (step S50). In this case, security monitoring device 1 outputs, to monitoring server 10, information indicating that security executor 112 is anomalous.

When there is no output from security executor 112 (No in S20), security monitoring device 1 determines whether the result that there is no output from security executor 112 is the result expected from the test pattern (step S60).

When the result that there is no output from security executor 112 is the result expected from the test pattern (Yes in step S60), security monitoring device 1 determines that security executor 112 is not anomalous (step S70). On the other hand, when the result that there is no output from security executor 112 is not the result expected from the test pattern (No in step S60), security monitoring device 1 determines that security executor 112 has been disabled (step S80). In this case, security monitoring device 1 outputs, to monitoring server 10, information indicating that security executor 112 is anomalous.

By repeatedly executing these steps, the security state of vehicle system 30 can be appropriately determined.

### Summary

Examples of the security monitoring device and the related technologies according to an aspect of the present disclosure will be described.

Security monitoring device 1 according to Example 1 includes: security executor 112 that executes security protection for vehicle system 30; test pattern instructor 113 that causes security executor 112 to run in a test pattern; and verifier 114 that verifies, based on an output of security executor 112 that has run in the test pattern, whether security executor 112 is anomalous.

In such a manner, by verifying, based on the output of security executor 112 that has run in the test pattern, whether security executor 112 is anomalous, it is possible to determine the security state of vehicle system 30. In addition, security monitoring device 1 can determine whether security executor 112 is operating normally under a normal policy.

Security monitoring device 1 according to Example 2 is the security monitoring device according to Example 1, in which the test pattern may include control information for causing security executor 112 to output an off-normal event different from a normal event.

In such a manner, by including, in the test pattern, control information for outputting an off-normal event, it is possible to verify whether security executor 112 is anomalous, based on whether an off-normal event has been output from security executor 112, for example. This makes it possible to determine the security state of vehicle system 30.

Security monitoring device 1 according to Example 3 is the security monitoring device according to Example 2, in which verifier 114 may: determine that security executor 112 is not anomalous, when log information indicating the output of security executor 112 matches the off-normal event that is a result expected from the test pattern; and determine that security executor 112 has been unauthorizedly manipulated, when the log information does not match the off-normal event.

In such a manner, it is possible to determine whether security executor 112 has been unauthorizedly manipulated, by determining whether the log information indicating the output of security executor 112 matches the off-normal event that is the result expected from the test pattern. This makes it possible to determine the security state of vehicle system 30. In addition, security monitoring device 1 can determine whether security executor 112 is operating normally under a normal policy.

Security monitoring device 1 according to Example 4 is the security monitoring device according to Example 2, in which verifier 114 may determine that security executor 112 has been disabled, when there is no output, from security executor 112, related to event information including the off-normal event.

Accordingly, it is possible to determine whether security executor 112 has been disabled. This makes it possible to determine the security state of vehicle system 30. Also, in this case, security monitoring device 1 can determine that security executor 112 is not operating normally under a normal policy.

Security monitoring device 1 according to Example 5 is the security monitoring device according to Example 2, in which verifier 114 may determine that security executor 112 has been unauthorizedly manipulated, when the off-normal event is output from security executor 112 at a time other than when test pattern instructor 113 has caused security executor 112 to run in a test pattern.

Accordingly, it is possible to determine whether security executor 112 has been unauthorizedly manipulated. This makes it possible to determine the security state of vehicle system 30. Also, security monitoring device 1 can determine that security executor 112 is not operating normally under a normal policy.

Security monitoring device 1 according to Example 6 is the security monitoring device according to Example 2, in which test pattern instructor 113 may cause security executor 112 to run in a test pattern at a predetermined timing, and verifier 114 may: determine that security executor 112 is not anomalous, when the off-normal event is output from security executor 112 at the predetermined timing; and determine that security executor 112 is anomalous, when the off-normal event is not output from security executor 112 at the predetermined timing.

Accordingly, it is possible to determine whether security executor 112 is anomalous at a predetermined timing at which anomaly check is necessary, for example. This makes it possible to precisely determine the security state of vehicle system 30.

Security monitoring device 1 according to Example 7 is the security monitoring device according to Example 2, in which test pattern instructor 113 may cause security executor 112 to run in a test pattern on a regular basis, and verifier 114 may: determine that security executor 112 is not anomalous, when the off-normal event is output from security executor 112 on the regular basis; and determine that security executor 112 is anomalous, when the off-normal event is not output from security executor 112 on the regular basis.

Accordingly, it is possible to determine on a regular basis whether security executor 112 is anomalous, even when vehicle system 30 is in a different state, for example. This makes it possible to precisely determine the security state of vehicle system 30.

Security monitoring device 1 according to Example 8 is the security monitoring device according to Example 2, in which test pattern instructor 113 may cause security executor 112 to run in test patterns in an order determined in advance, and verifier 114 may: determine that security executor 112 is not anomalous, when off-normal events are output from security executor 112 in the order determined in advance, the off-normal events each being the off-normal event; and determine that security executor 112 is anomalous, when the off-normal events are not output from security executor 112 in the order determined in advance.

Accordingly, even when a different protection rule is applied, for example, it is possible to determine, in an order determined in advance, whether security executor 112 is anomalous. This makes it possible to precisely determine the security state of vehicle system 30.

Security monitoring device 1 according to Example 9 is the security monitoring device according to Example 2, in which test pattern instructor 113 may cause security executor 112 to run in test patterns on a random basis, and verifier 114 may: determine that security executor 112 is not anomalous, when off-normal events are output from security executor 112 on the random basis on which security executor 112 has run in the test patterns, the off-normal events each being the off-normal event; and determine that security executor 112 is anomalous, when the off-normal events are not output from security executor 112 on the random basis on which security executor 112 has run in the test patterns.

Accordingly, it is possible to make security executor 112 less susceptible to cyberattacks, for example. This makes it possible to enhance the security of vehicle system 30.

Security monitoring device 1 according to Example 10 is the security monitoring device according to Example 2, in which test pattern instructor 113 may cause security executor 112 to run in a test pattern when a predetermined event occurs, and verifier 114 may: determine that security executor 112 is not anomalous, when the off-normal event is output from security executor 112 in response to occurrence of the predetermined event; and determine that security executor 112 is anomalous, when the off-normal event is not output from security executor 112 in response to occurrence of the predetermined event.

Accordingly, it is possible to determine whether security executor 112 is anomalous, according to an event for which anomaly check is necessary, for example. This makes it possible to precisely determine the security state of vehicle system 30.

Security monitoring device 1 according to Example 11 is the security monitoring device according to any one of Examples 1 to 10, in which security executor 112, test pattern instructor 113, and verifier 114 may be provided in the same host computer.

Accordingly, it is possible to determine the security state of vehicle system 30 without having to add an external device.

Security monitoring device 1 according to Example 12 is the security monitoring device according to any one of Examples 1 to 10, in which each of security executor 112, test pattern instructor 113, and verifier 114 may be provided in a different host computer.

Accordingly, it is possible to determine the security state of vehicle system 30 from a region safer than security protection target 111, for example.

Security monitoring device 1 according to Example 13 is the security monitoring device according to any one of Examples 1 to 10, in which each of security executor 112, test pattern instructor 113, and verifier 114 may be provided in a different ECU.

Accordingly, it is possible to determine the security state of vehicle system 30 from a region safer than security protection target 111, for example.

Security monitoring device 1 according to Example 14 is the security monitoring device according to any one of Examples 2 to 10, in which test pattern instructor 113 may cause each of first security executor 112a and second security executor 112b different from first security executor 112a to run in a test pattern in an order determined in advance, first security executor 112a being the security executor described above, and verifier 114 may determine that first security executor 112a and second security executor 112b are not anomalous, when the off-normal event is output from each of first security executor 112a and second security executor 112b in the order determined in advance.

With this, whether first security executor 112a and second security executor 112b are anomalous can be determined at the same time.

Security monitoring device 1 according to Example 15 is the security monitoring device according to any one of Examples 1 to 10, in which security executor 112 may execute security protection related to discretionary access control or mandatory access control, and test pattern instructor 113 may cause security executor 112 to run in a test pattern to cause execution of an unpermitted access to security executor 112.

This makes it possible to appropriately determine whether security executor 112 is anomalous.

Security monitoring device 1 according to Example 16 is the security monitoring device according to any one of Examples 1 to 10, in which security executor 112 may execute security protection related to system call restriction, and test pattern instructor 113 may cause security executor 112 to run in a test pattern to cause execution of an unpermitted system call on security executor 112.

This makes it possible to appropriately determine whether security executor 112 is anomalous.

Security monitoring device 1 according to Example 17 is the security monitoring device according to any one of Examples 1 to 10, in which security executor 112 may execute security protection related to isolation of a namespace, and test pattern instructor 113 may cause security executor 112 to run in a test pattern to check the namespace for presence of a process or resource of another namespace different from the namespace.

This makes it possible to appropriately determine whether security executor 112 is anomalous.

Security monitoring device 1 according to Example 18 is the security monitoring device according to any one of Examples 1 to 10, in which security executor 112 may execute security protection related to restriction on a computational resource, and test pattern instructor 113 may cause security executor 112 to run in a test pattern to: check a set value of the computational resource of security executor 112; or cause consumption of the computational resource of security executor 112 to a predetermined value.

This makes it possible to appropriately determine whether security executor 112 is anomalous.

Security monitoring device 1 according to Example 19 is the security monitoring device according to any one of Examples 1 to 10, in which security executor 112 may execute security protection related to communication monitoring, and test pattern instructor 113 may cause security executor 112 to run in a test pattern to cause transmission of an unauthorized signal to security executor 112.

This makes it possible to appropriately determine whether security executor 112 is anomalous.

Security monitoring device 1 according to Example 20 is the security monitoring device according to any one of Examples 1 to 10, in which security executor 112 may execute security protection related to software of vehicle system 30, and test pattern instructor 113 may cause security executor 112 to run in a test pattern to cause the software to be temporarily tampered with.

This makes it possible to appropriately determine whether security executor 112 is anomalous.

Security monitoring device 1 according to Example 21 is the security monitoring device according to any one of Examples 1 to 10 and may further include: countermeasure taker 115 that takes a countermeasure in accordance with whether security executor 112 is anomalous, and countermeasure taker 115 may avoid outputting information indicating that security executor 112 is anomalous, when verifier 114 determines that security executor 112 is not anomalous.

In such a manner, when security executor 112 is not anomalous, outputting of information indicating that security executor 112 is anomalous is avoided, thereby inhibiting an increase in unnecessary processing.

Security monitoring device 1 according to Example 22 is the security monitoring device according to any one of Examples 1 to 10, and may further include: countermeasure taker 115 that takes a countermeasure in accordance with whether security executor 112 is anomalous, and when an event different from the off-normal event is output from security executor 112 that has run in the test pattern, countermeasure taker 115 may output information indicating that security executor 112 is anomalous.

Accordingly, it is possible to notify that security executor 112 is anomalous.

Security monitoring device 1 according to Example 23 is the security monitoring device according to any one of Examples 2 to 10 and may further include: countermeasure taker 115 that takes a countermeasure in accordance with whether security executor 112 is anomalous, and when the off-normal event is not output from security executor 112 that has run in the test pattern, countermeasure taker 115 may reboot security executor 112.

Accordingly, it is possible to restore anomalous security executor 112 to its normal state.

Security monitoring device 1 according to Example 24 is the security monitoring device according to any one of Examples 2 to 10, and may further include: countermeasure taker 115 that takes a countermeasure in accordance with whether security executor 112 is anomalous, and countermeasure taker 115 may avoid rebooting security executor 112 when the off-normal event is output from security executor 112 at a time other than when security executor 112 has been caused to run in the test pattern.

Accordingly, damage caused an anomaly can be inhibited from spreading.

Security monitoring system 2 according to Example 25 includes: security monitoring device 1 according to any one of Examples 1 to 24; and monitoring server 10 that communicates with security monitoring device 1 via external network 20.

It is possible to provide security monitoring system 2 capable of determining the security state of vehicle system 30.

A security monitoring method according to Example 26 includes: causing security executor 112 to run in a test pattern, security executor 112 executing security protection for vehicle system 30; and verifying, based on an output of security executor 112 that has run in the test pattern, whether security executor 112 is anomalous.

In such a manner, by verifying, based on the output of security executor 112 that has run in the test pattern, whether security executor 112 is anomalous, it is possible to determine the security state of vehicle system 30.

### Other Embodiments

Although the security monitoring device and the related technologies according to one or more aspects have been described so far based on the above embodiment, the present disclosure is not limited to the above embodiment. Various modifications of the above embodiment as well as forms resulting from combinations of constituent elements from different embodiments that may be conceived by those skilled in the art may be included within the scope of one or more aspects so long as they do not depart from the essence of the present disclosure.

Note that in the above embodiment, each constituent element may be configured as dedicated hardware or may be implemented by executing a computer program suitable for the constituent element. Each constituent element may be implemented by means of a program executor, such as a CPU or a processor, reading and executing the computer program recorded on a recording medium such as a hard disk or a semiconductor memory.

In addition, the functions of the security monitoring device according to the above embodiment may be partially or entirely implemented by a processor, such as a CPU, executing a computer program.

Some or all of the constituent elements included in each device described above may be configured as an integrated circuit (IC) card or a standalone module attachable to and detachable from each device. The IC card or module is a computer system including, for example, a microprocessor, ROM, and random-access memory (RAM). The IC card or module may include the above-described super multifunctional large scale integration (LSI) circuit. The IC card or module achieves the functions thereof by the microprocessor operating in accordance with the computer program. The IC card or module may be tamperproof.

The present disclosure may be the method described above. Also, the present disclosure may be a computer program that implements the method by using a computer, or a digital signal of the computer program. Further, the present disclosure may be a non-transitory computer-readable recording medium, such as a flexible disk, a hard disk, a CD-ROM, a magneto-optical disk (MO), a digital versatile disc (DVD), a DVD-ROM, a DVD-RAM, a Blu-ray Disc (BD; registered trademark), semiconductor memory, etc., having recording thereon the computer program or the digital signal. Furthermore, the present disclosure may be the digital signal recorded on these recording media. Also, the present disclosure may transmit the computer program or the digital signal via, for example, a telecommunication line, a wireless or wired communication line, a network such as the Internet, or data broadcasting. Further, the present disclosure may be implemented as a computer system including (i) memory having the computer program stored therein, and (ii) a microprocessor that operates according to the computer program. Furthermore, the present disclosure may be implemented by another independent computer system by recording the program or the digital signal on the medium and transporting it, or by transporting the program or the digital signal via the network, etc.

Note that in the above embodiment, security measures for automobiles have been described as an example of application of the present disclosure; however, the range of application of the present disclosure is not limited to this. For example, the present disclosure may be applied not only to automobiles but also to mobile entities such as construction equipment, farm machines, ships, or airplanes.

While various embodiments have been described herein above, it is to be appreciated that various changes in form and detail may be made without departing from the spirit and scope of the present disclosure as presently or hereafter claimed.

### Further Information about Technical Background to this Application

The disclosure of the following patent application including specification, drawings, and claims is incorporated herein by reference in its entirety: Japanese Patent Application No. 2024-229231 filed on December 25, 2024.

### Industrial Applicability

The security monitoring device according to the present disclosure is applicable to a virtual ECU and the like having a function of detecting an anomaly in a security state, for example.

1. A security monitoring device comprising:
a security executor that executes security protection for a vehicle system;
a test pattern instructor that causes the security executor to run in a test pattern; and
a verifier that verifies, based on an output of the security executor that has run in the test pattern, whether the security executor is anomalous.

2. The security monitoring device according to claim 1, wherein
the test pattern includes control information for causing the security executor to output an off-normal event different from a normal event.

3. The security monitoring device according to claim 2, wherein
the verifier:
determines that the security executor is not anomalous, when log information indicating the output of the security executor matches the off-normal event that is a result expected from the test pattern; and
determines that the security executor has been unauthorizedly manipulated, when the log information does not match the off-normal event.

4. The security monitoring device according to claim 2, wherein
the verifier determines that the security executor has been disabled, when there is no output, from the security executor, related to event information including the off-normal event.

5. The security monitoring device according to claim 2, wherein
the verifier determines that the security executor has been unauthorizedly manipulated, when the off-normal event is output from the security executor at a time other than when the test pattern instructor has caused the security executor to run in a test pattern.

6. The security monitoring device according to claim 2, wherein
the test pattern instructor causes the security executor to run in a test pattern at a predetermined timing, and
the verifier:
determines that the security executor is not anomalous, when the off-normal event is the output from the security executor at the predetermined timing; and
determines that the security executor is anomalous, when the off-normal event is not output from the security executor at the predetermined timing.

7. The security monitoring device according to claim 2, wherein
the test pattern instructor causes the security executor to run in a test pattern on a regular basis, and
the verifier:
determines that the security executor is not anomalous, when the off-normal event is output from the security executor on the regular basis; and
determines that the security executor is anomalous, when the off-normal event is not output from the security executor on the regular basis.

8. The security monitoring device according to claim 2, wherein
the test pattern instructor causes the security executor to run in test patterns in an order determined in advance, and
the verifier:
determines that the security executor is not anomalous, when off-normal events are output from the security executor in the order determined in advance, the off-normal events each being the off-normal event; and
determines that the security executor is anomalous, when the off-normal events are not output from the security executor in the order determined in advance.

9. The security monitoring device according to claim 2, wherein
the test pattern instructor causes the security executor to run in test patterns on a random basis, and
the verifier:
determines that the security executor is not anomalous, when off-normal events are output from the security executor on the random basis on which the security executor has run in the test patterns, the off-normal events each being the off-normal event; and
determines that the security executor is anomalous, when the off-normal events are not output from the security executor on the random basis on which the security executor has run in the test patterns.

10. The security monitoring device according to claim 2, wherein
the test pattern instructor causes the security executor to run in a test pattern when a predetermined event occurs, and
the verifier:
determines that the security executor is not anomalous, when the off-normal event is output from the security executor in response to occurrence of the predetermined event; and
determines that the security executor is anomalous, when the off-normal event is not output from the security executor in response to occurrence of the predetermined event.

11. The security monitoring device according to claim 1, wherein
the security executor, the test pattern instructor, and the verifier are provided in a same host computer.

12. The security monitoring device according to claim 1, wherein
each of the security executor, the test pattern instructor, and the verifier is provided in a different host computer.

13. The security monitoring device according to claim 1, wherein
each of the security executor, the test pattern instructor, and the verifier is provided in a different electronic control unit (ECU).

14. The security monitoring device according to claim 2, wherein
the test pattern instructor causes each of a first security executor and a second security executor different from the first security executor to run in a test pattern in an order determined in advance, the first security executor being the security executor, and
the verifier determines that the first security executor and the second security executor are not anomalous, when the off-normal event is output from each of the first security executor and the second security executor in the order determined in advance.

15. The security monitoring device according to claim 1, wherein
the security executor executes security protection related to isolation of a namespace, and
the test pattern instructor causes the security executor to run in a test pattern to check the namespace for presence of a process or resource of another namespace different from the namespace.

16. The security monitoring device according to claim 1, wherein
the security executor executes security protection related to software of the vehicle system, and
the test pattern instructor causes the security executor to run in a test pattern to cause the software to be temporarily tampered with.

17. The security monitoring device according to claim 1, further comprising:
a countermeasure taker that takes a countermeasure in accordance with whether the security executor is anomalous, wherein
the countermeasure taker avoids outputting information indicating that the security executor is anomalous, when the verifier determines that the security executor is not anomalous.

18. The security monitoring device according to claim 2, further comprising:
a countermeasure taker that takes a countermeasure in accordance with whether the security executor is anomalous, wherein
when the off-normal event is not output from the security executor that has run in the test pattern, the countermeasure taker outputs information indicating that the security executor is anomalous.

19. A security monitoring system comprising:
the security monitoring device according to claim 1; and
a monitoring server that communicates with the security monitoring device via an external network.

20. A security monitoring method comprising:
causing a security executor to run in a test pattern, the security executor executing security protection for a vehicle system; and
verifying, based on an output of the security executor that has run in the test pattern, whether the security executor is anomalous.
